(19) United States
(12) Patent Application Publication
(10) Pub. No.: US 2008/0082316 A1
(43) Pub. Date: Apr. 3, 2008

(54) Method and System for Generating, Rating, and Storing a Pronunciation Corpus

(75) Inventors: Chun Yu Tsui, Foster City, CA (US); Chi Shing Kwan, Foster City, CA (US)

Correspondence Address: CHI SHING KWAN, 839 CATAMARAN STREET, APT 4, FOSTER CITY, CA, 94404, US

(73) Assignees: Ms. Chun Yu Tsui, Foster City, CA (US); Mr. Chi Shing Kwan, Foster City, CA (US)

(21) Appl. No.: 11/861,281

(22) Filed: Sep. 26, 2007

Related U.S. Application Data
(60) Provisional application No. 60/827,703, filed on Sep. 30, 2006.

(51) Int. Cl. G06F 17/28

(52) U.S. Cl. 704/4

(57) ABSTRACT

A method and system of generating, rating, and storing a pronunciation corpus is provided. The system (“Dico”) is an interactive system resident on a data network such as the Internet or intranet. Dico provides a platform for maintaining and serving the corpus in such a way that the corpus can be expanded continuously with new phrases and new pronunciations received from the users of Dico. A user of Dico can take the role of a contributor or a listener. Contributors use Dico's contribution tool to contribute new pronunciations and phrases to Dico's corpus. Listeners use Dico's playback tool to listen to the contributed pronunciations in Dico's corpus. Listeners can also rate the contributed pronunciations using Dico's rating tool. Dico uses the ratings to determine the quality of the contributed pronunciations and use this information to rank the pronunciations. The collective actions and knowledge of Dico's users enable Dico to determine the best pronunciations for each phrase in its corpus.

### CROSS-REFERENCE TO RELATED APPLICATIONS

This application claims the benefit of provisional patent application with application No. 60/827,703, filed on 2006 Sep. 30 by the present inventors.

### FIELD OF THE INVENTION

The present invention relates to a computer method and system for generating a corpus of pronunciations of words, and more particularly, to a method and system for carrying out the generation using an interactive robot resident in a data network.

### BACKGROUND OF THE INVENTION

Phrases in various languages may be useful to people who may or may not know the corresponding languages. Such phrases include names, single words, and multi-word phrases. For example, certain American products may best be referred to by their English brand names, even in a foreign country speaking another language. Also, new phrases are created in different languages everyday. Some of these new phrases are intended to be pronounced in a particular way. For example, “iPod”, a product name trademarked by Apple Incorporated (United States Patent and Trademark Office trademark serial number 78521796), is intended to be pronounced as “i-pod”, with “i” pronounced as if it is an individual letter. If one uses standard English phonetics to pronounce “ipod”, it would have been pronounced as “e-pod”, with a very short and light “e” sound in place of the “i” sound. Many trademarked names are new words that are intended to be pronounced unconventionally.

There is thus a general need for people to find out the correct pronunciations of phrases. Today, people typically are able to do so in a number of ways, such as by consulting a dictionary, text-to-speech software, any materials with pronunciations available in audible sources, or their corresponding encoding in a phonetic encoding format, such as the International Phonetic Alphabet (“IPA”), or people who speak the related languages.

However, not all pronunciations that people are interested in can be found and learnt conveniently. A dictionary is usually tailored for one language. Most of the dictionaries do not carry all people's names, multi-word phrases, or trademarked product names that people are interested in learning to pronounce correctly. Phonetic notation systems, such as the IPA, require one to acquire the skills in order to use them proficiently. Audible media materials, such history documentary films, may contain names that are of interests. However, people often need to search multiple sources before they can locate the pronunciations of desired phrases. Some dictionaries have multimedia materials to help with understanding and pronunciation. An example is a CDROM edition of the Oxford Advanced Learners' Dictionary (OALD). In addition to depicting the pronunciations of the words included in the dictionary, the OALD includes audio reproduction of some of the words. However, a user of the dictionary seeking multiple pronunciations for the same word in different style cannot achieve that from the OALD. The OALD has only on pronunciation for the each, with the exception of two pronunciations for words that are pronounced differently in Britain and in North America. In addition, when words are concatenated to form phrases, their pronunciations may change. In some language, such as French, the changes are substantial.

Text-to-speech (“TTS”) software typically synthesizes audible pronunciations of phrases using a combination of phonetic rules, recorded sound, and machine learning techniques. It is usually difficult or costly to use TTS technology to generate arbitrary and unconventional pronunciations, such as in the “iPod” example.

There are some online systems wherein their content is provided by users of those systems. An example is Wikipedia.org. It is an interactive Internet system designed to receive and organize content contributed by its users to form an encyclopedia (Some people skilled in the art consider Wikipedia.org may be an implementation of the invention disclosed in U.S. Pat. No. 6,052,717, and in continuation U.S. Pat. Nos. 6,411,993 and 6,721,788). Some of the materials include pronunciation information as well as audio reproduction of words and phrases. However, Wikipedia.org and the invention disclosed in U.S. Pat. No. 6,052,717 have constraints similar to OALD. Usually, there is only one pronunciation for a phrase on the current page of a topic, again rendering the goal of seeking multiple pronunciations for the same phrase in different styles inconvenient. In addition, although the history of previous edits, which may contain alternative previous pronunciations, on the topic can be retrieved, it is inconvenient to review the history pages and users of Wikipedia.org do not always do so. Furthermore, there is little information about which pronunciations are accurate. The users who are interested in the pronunciations usually cannot tell which the difference, because usually they would be those who do not know how to pronounce the phrase in the first place. This may make it less efficient to learn to pronounce a phrase.

Yet another online system is Dictionary.com. Dictionary.com responds to requests for definitions of words. Some of Dictionary.com's responses contain audio reproduction of the words. However, it is constrained similarly to OALD—most of the audio materials are for a single word. Changes in pronunciation when concatenated in a phrase cannot be reproduced conveniently. In addition, users usually cannot find pronunciations for conjugations of the words available in Dictionary.com.

A straightforward way to learn a pronunciation is to find a person, or a few persons, who speaks the language to pronounce it. Although probably the most effective way to learn to pronounce phrases, it is often inconvenient to find someone who speaks a particular language at any time in any place.

Furthermore, as demographic, cultural, and other social factors change, generally accepted pronunciations of phrases may change over time. Therefore, any pronunciation systems that are rule-based are typically difficult or costly to be made adaptive to such changing and evolving environment.

It is therefore an object of the present invention to provide an economical and convenient process and system that facilitate the generation and evolution of an accurate and up-to-date pronunciation corpus, whereby the corpus can be expanded continuously with new phrases and new pronunciations received from the users of the system.

### SUMMARY OF THE INVENTION

An embodiment of the present invention provides a method and system for maintaining and serving a pronunciation corpus. The system is called Dico. It is configured in such a way that the corpus can be expanded continuously with new phrases and new pronunciations received from the users of Dico.

Users of Dico can preferably take the role of a contributor or a listener. Contributors add pronunciations to Dico. Dico stores the pronunciations and makes them available to listeners. Listeners listen to the pronunciations stored in Dico, and can rate the pronunciations, preferably in terms of the accuracy, helpfulness, and likeableness of the pronunciations.

Dico thus collects a computer-stored pronunciation corpus by electronically accepting pronunciations from contributors. Preferably, there are multiple contributors contributing pronunciations for each phrase in Dico's corpus. A Contribution tool provided by Dico makes it convenient for contributors to add pronunciations. A Playback tool provided by Dico makes it convenient for listeners to find and listen to the pronunciations. A Rating tool provided by Dico makes it convenient for listeners to rate the pronunciations.

Furthermore, Dico gains knowledge of the quality of the pronunciations in its corpus by considering the listener ratings for each pronunciation, as well as other system statistics collected by Dico during its operations, such as the number of listeners listened to each pronunciation. In addition, Dico can continue to accept contributions and ratings, even for phrases that it already has ample pronunciations. Therefore, changes in the pronunciations of phrases are usually reflected in the changes in new contributions and ratings. Over time, with many contributions, ratings, and system statistics, Dico is able to determine the prevailing most accurate, helpful, and likeable pronunciations for each phrase in its corpus.

With the method described above, Dico makes the most straightforward but inconvenient solution described in the background section—having a person who speaks the language to pronounce a desired phrase to a listener who wants to learn to pronounce that phrase—convenient and economical. Using Dico, the learning process is even more effective. It is because for each phrase, there are many contributed pronunciations to learn from, and the method of rating described above provides two additional ways for Dico to assist listeners in finding the best pronunciations. First, Dico encourages other users who know the corresponding languages to verify the accuracy of the contributed pronunciations. Second, Dico encourages other listeners who have listened to the pronunciations to rate how helpful and likeable the pronunciations are to them. For each contributed pronunciation, Dico presents to the listeners a summary of the ratings for accuracy, helpfulness and likeableness. Therefore, listeners are able to readily identify reliable and helpful pronunciations.

Dico essentially enables people to learn to pronounce from each other over the Internet, in a reliable and helpful manner. The rest of the summary section further describes the various tools used by Dico to achieve this function.

In a preferred embodiment, the contribution tool, playback tool, and rating tool are organized in the form of web pages. Therefore, in this embodiment, Dico is a web application controlled centrally by a web server called Dico Server. Users can access and operate the tools of Dico via web browsers on their client computing devices, typically personal computers (“PCs”) and mobile phones.

The contribution tool, playback tool, and rating tool operate preferably as follows:

A contributor interacts with the contribution tool to make pronunciation contributions. The contribution tool displays a list of phrases needing contributions. This list can be generated manually, such as by manually inputting it to the Dico system. The list can also be generated semi-automatically or automatically by Dico server, preferably using inputs from listeners via the playback tool (see below). The contributor can select a phrase from the list to contribute or can simply suggest a phrase to contribute without any reference to the list. The contributor then contributes a pronunciation by transmitting a media file to Dico server. The media file contains audio material of the pronunciation, typically a recording of the contributor's own utterance of the phrase. Dico server records this media file in its databases.

A listener interacts with the playback tool to listen to the contributed pronunciations. The playback tool allows the listener to search for a phrase he or she would like to hear it pronounced. If there is a match for the search, the playback tool displays a list of contributed pronunciations for that phrase, along with a summary of ratings for each pronunciation. If there is no match for the search, the playback tool asks the listener whether he or she would like the phrase to be added to the list of phrases needing contributions. This is the list that is displayed in the contribution tool, described above.

In the case of a match, the listener can select a pronunciation from the list and requests Dico server to transmit the pronunciation to him or her. In this step, the playback tool receives a media file in which the audio material of the contributed pronunciation is embedded. The playback tool then plays the media file. Upon listening to the pronunciation, the listener can use the rating tool to rate the pronunciation. The listener can repeat the above process to select, listen to, and rate other pronunciations from the list.

The rating tool displays a number of criteria upon which to rate the pronunciations. Examples of such criteria are accuracy, helpfulness, and likeableness. They can be rated in a numerical scale, such as a five-star system: one star being poor and five stars being excellent. Another rating scale can be binary: yes or no. A binary scale is suitable for rating accuracy. Preferably, only listeners who know the language of the pronunciation can rate its accuracy. Rating tool then transmits the ratings it received from the listener to Dico server. Dico server records these ratings in its databases.

The playback is considered to be operating in a normal mode when it carries out the process described above. However, the playback tool also operates in a second mode called suggestion mode. In this mode, Dico selects a list of pronunciations for a user to listen to, instead of allowing the user to specify a phrase that he or she likes to hear, as in the normal mode. This way, Dico is able to encourage more ratings for a list of pronunciations of its own choosing. By including in the list pronunciations that are pronounced in languages that the user speaks, Dico is able to gather additional ratings for the accuracy criterion.

In addition to interacting with users via the tools, Dico server collects system statistics during its interactions with contributors and listeners. Examples of such system statistics are: the number of listeners requesting a particular pronunciation, the number of ratings inputted for a particular pronunciation, Internet address of the listeners, and the grand total of listeners for a particular contributor.

Preferably, Dico server aggregates the ratings and system statistics into a numerical and relative quality measure for each pronunciation. This relative quality measure can be used to direct the playback tool. For example, the playback tool in normal mode can display the list of pronunciations in a descending order, in terms of relative quality. This will reduce the time it takes for listeners to locate high quality pronunciations. Listeners therefore benefit from the collective actions and knowledge of other users of the Dico system.

### BRIEF DESCRIPTION OF THE DRAWINGS

FIG. 1 is a system diagram showing a Dico server and Dico clients interconnected by a data network in one embodiment of the present invention.

FIG. 2 is a detailed diagram of a Dico server and Dico clients interconnected by a data network, illustrating an embodiment of the present invention.

FIG. 3 illustrates an embodiment of the welcome web page presented by a Dico server.

FIG. 4 is a flow diagram of the user registration process.

FIG. 5 is a flow diagram of the login process.

FIG. 6 is a flow diagram of the contribution process.

FIG. 7 is a flow diagram of the playback process in normal mode.

FIG. 8 is a flow diagram of the rating process.

FIG. 9 illustrates the relationship between some of the more important data in the databases maintained by Dico server.

FIG. 10 illustrates an embodiment of a user interface of the playback process in normal mode.

FIG. 11 is a flow diagram of the playback process in suggestion mode.

FIG. 12 illustrates an embodiment of a user interface of the playback process in suggestion mode.

### DETAILED DESCRIPTION OF THE INVENTION

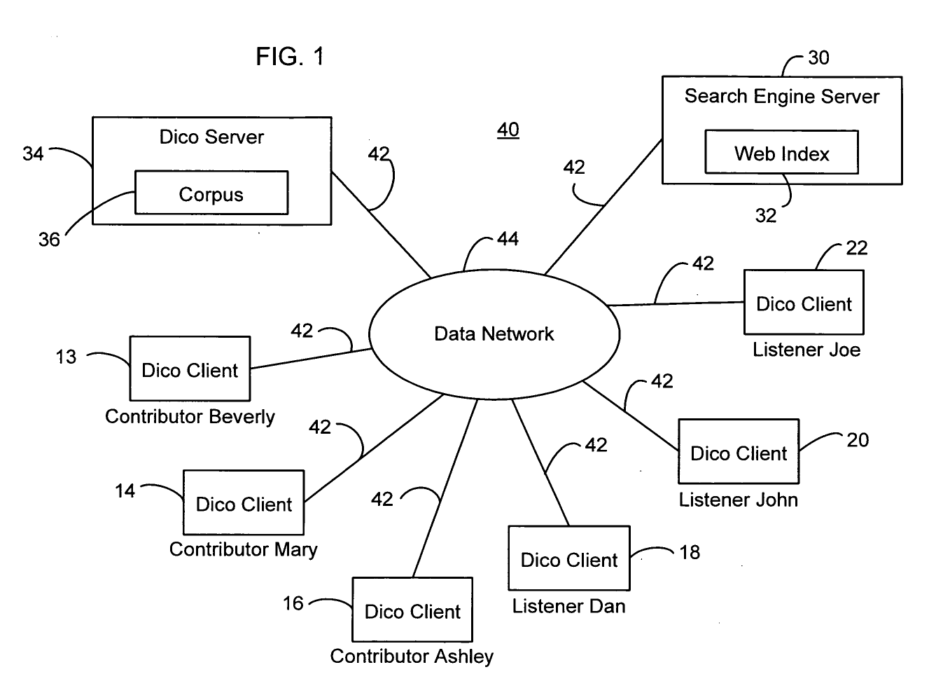

In a preferred embodiment, the system 40 for interactively generating a pronunciation corpus is shown in FIG. 1. This system is called the Dico system, or simply as Dico. In this embodiment, Dico is a web application. Web server computer 34 is called the Dico Server. It is interconnected with Dico clients 13, 14, 16, 18, 20, and 22 via data network 44. Users interact with Dico server 34 via web browsers on their client computers 13, 14, 16, 18, 20, and 22. The browsers display web pages served by Dico server 34 and handle communications between client computers 13, 14, 16, 18, 20, and 22 and Dico server 34. Also connected to the data network 44 is a search engine server 30. Data network 44 is preferably a packet-based network. But it may also be a circuit-based network. Examples of packet-based networks are the Internet (both wired and wireless), an intranet, a local area network (“LAN”), and wide area network (“WAN”) using Internet protocols. Examples of circuit-based networks are the telephone network and circuit-switched mobile phone networks. Data network 44 preferably also supports network connections using both packet-based data networks and circuit-based networks. Communication paths 42 are modem lines, LAN, WAN, wireless data and telephone network, telephone lines, VoIP, or mobile phone connections.

Contributors at clients 13, 14, and 16 can contribute pronunciations to the pronunciation corpus 36 stored at Dico server 34. The contributed pronunciations can be in any media format, such as an audio-only format (e.g., the Moving Picture Expert Group's (“MPEG”) MPEG-1 Audio Layer 3 format, also known as “MP3”), audio-and-video file (e.g., the Windows Media Video format), or textual encoding in phonetic symbols, such as the IPA. It can also be computer source code or computer executable code, which, when executed in a suitable execution environment, causes an audio output interface of the client computers 13, 14, 16, 18, 20, and 22 to produce an audible pronunciation. One example of source code is code written in Java, a computer language developed by Sun Microsystems. They can be compiled into Java byte code, which can then be executed in a Java virtual machine to produce an audible pronunciation. Another example is executable code generated from C++ source code, which can be executed directly on a central processing unit (“CPU”) of a computer.

Typically, contributors are required register with the Dico system 40 prior to making any contributions.

Listeners at clients 18, 20, and 22 can listen to the contributed pronunciations in corpus 36. Listeners can also rate the quality of the pronunciations, preferably after they have listened to them. Although listeners are typically not required to register with Dico system 40 prior to listening to any pronunciations, they typically are required registered to rate the pronunciations.

Dico server 34 can allow a search engine server 30 to store the phrases available in its corpus 36 in the search engine's web index 32. In a preferred embodiment, Dico server 34 can register its presence with a search provider, such as Google Incorporated, and provide a list of uniform resource locators (“URLs”) to the phrases in its corpus 36 to the search provider.

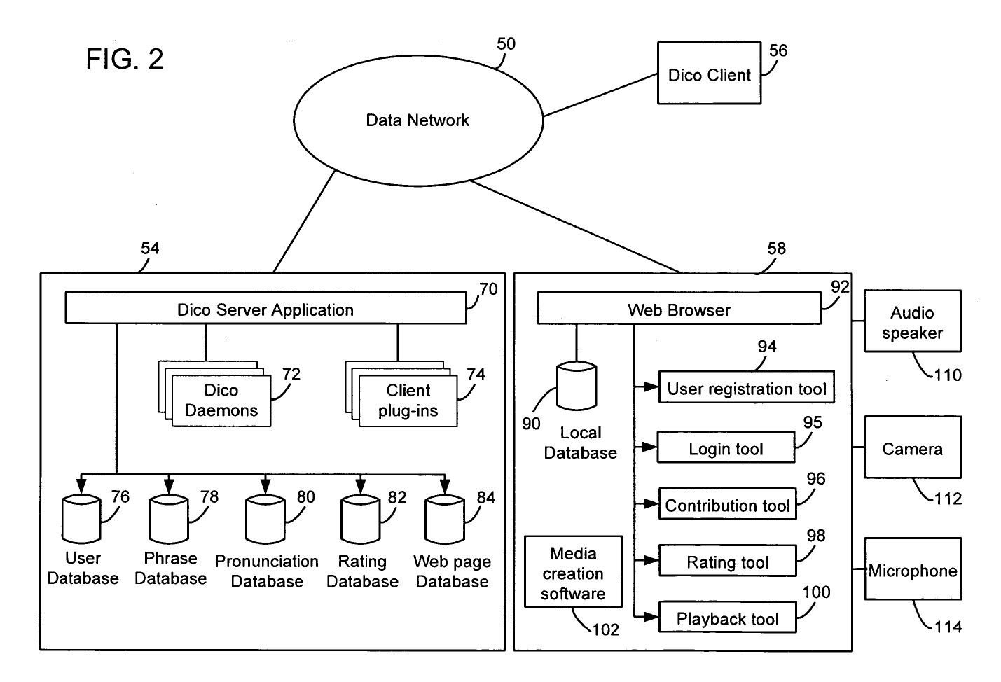

In a preferred embodiment, FIG. 2 is a more detailed view of the server and client computers of FIG. 1. Dico server 54 is interconnected with Dico clients 56 and 58 via data network 50. Dico server 54 is preferably a computer or clusters of computers sufficiently powerful to handle Web traffic from numerous clients. If desired, the functions of server 54 can be divided among several servers, which can be geographically remote from each other. For example, the database functions of server 54 could be provided by a database server connected to server 54 through data network 50. Dico clients 56 and 58 can be PCs. They can also be other computing devices, such as a Personal Digital Assistant (“PDA”) devices or mobile phones. They can also be other communication devices, such as traditional voice-only telephones or voice-only mobile phone.

Dico functions are preferably performed by executing instructions with Dico server 54 and with clients 56 and 58. In particular, Dico server application 70 controls databases 76, 78, 80, 82, and 84, in which various user, corpus and user interface information are stored. Dico server application 70 also receives Hypertext Transfer Protocol (“HTTP”) requests to access web pages identified by URLs and provides the web pages to various client systems. Dico server application 70 further interact with client systems 56 and 58 to partially provide user interface for and coordinate various client tools 94, 95, 96, 98, and 100.

Dico daemons 72 are programs associated with Dico server application 70. They run continuously or semi-continuously in the background. Dico daemons 72 perform functions such as collecting system statistics, estimating quality of contributed pronunciations, handling exchanges with the search engine server 30, adding phrases to phrase database 78, and advertising.

A majority of client functions of Dico system 40 are preferably carried out using web browser 92. In addition, the functions of web browser 92 can be enhanced by client plug-ins to carry out some of the client functions of Dico system 40. Client plug-ins 74 are downloadable and executable programs that can be run on clients 56 and 58. They execute in conjunction with web browser 92 to add additional functions to web browser 92. Preferably, client plug-ins 74 are packaged as Java Applets, Microsoft's ActiveX controls, Adobe's Flash applications, or executable web browser plug-ins. Downloading of the client plug-ins 74 can be accomplished using standard techniques, such as the File Transfer Protocol (“FTP”) or HTTP. These client plug-ins can be provided by Dico server 54 or from any other software manufacturers. An example of one such client plug-in is QuickTime, manufactured by Apple Incorporated. When client plug-ins 74 are downloaded onto client 58, they form part of tools 94, 95, 96, 98, and 100. Tools 94, 95, 96, 98, and 100 are primarily web pages, which include components in Hypertext Markup Language (“HTML”), client-side scripts (e.g., Javascript), and preferably also client plug-ins (for example, Java applets, ActiveX controls, Flash applications, and other executable plug-ins for browser 92). Generation of the web pages of tools 94, 95, 96, 98, and 100 is accomplished by execution of instructions of Dico server application 70 on Dico server 54.

User database 76 contains user information such as user names, passwords, user identity numbers (“UID”), and language ability of the Dico users. Phrase database 78 contains information on the phrases in Dico's corpus 36, such as computer-readable encodings of the phrases and their languages. Examples of suitable computer-readable encodings are the American Standard Code for Information Interchange (“ASCII”) and Unicode. Pronunciation database 80 contains information on the pronunciations contributed by contributors, such as the audio materials of the pronunciations, the video materials of the pronunciations, timestamps of when the contributions were made, and UIDs of the contributors. Rating database 82 contains information about the ratings inputted by listeners, such as the numerical ratings for helpfulness, UIDs of the listeners, and timestamps of when the ratings were inputted. Web page database 84 contains template web pages. These template web pages are used by Dico server application 70 to generate the web pages for tools 94, 95, 96, 98, and 100.

More detailed information about the organization of the databases 76, 78, 80, 82, and 84 and the various tools 94, 95, 96, 98, and 100 is provided in a later section.

Web browser 92 is preferably a common web browser, such as Microsoft Internet Explorer, Mozilla Foundation's Firefox, and Netscape's web browser. Web browser 92 also stores a local database 90. Local database 90 stores temporary or semi-permanent information in data packages known as “cookies”. Local database 90 typically contains temporary information about a login session, partially controlled by client-side scripts of the login tool 95 and partially controlled by Dico server 54. It can also contain semi-permanent preference data selected by a user of client 58.

In addition to the standard input-output devices for a PC, such as a monitor, a keyboard, and a mouse, client 58 preferably also has additional peripheral devices for audio and video recording and playback purposes. Audio speaker 110 is typically used for playback of pronunciations. Camera 112 is typically used by a contributor to record static images or video materials for his or her contributions. Microphone 114 is typically used by a contributor to record audio materials for his or her contributions. Preferably, the microphone 114 and camera 112 are controlled by media creation software 102, which is used by a contributor to record pronunciations to a computer file. In another embodiment, the microphone 114 and camera 112 are controlled by the client plug-ins 74 and client-side scripts of contribution tool 96.

Users of Dico system 40 can be both contributors and listeners. Contributors contribute pronunciations to corpus 36. Listeners can listen to pronunciations stored in corpus 36, and optionally rate the pronunciations. Contributors are typically required to register with Dico to make contributions. In addition, a contributor typically first establish a login session with Dico server 54 before Dico server 54 stores his or her contributions in its phrase and pronunciation databases 78 and 80. Listeners do not need to be registered or login if they do not rate the pronunciations. However, a listener are typically required to be registered and first establish a login session with Dico server 54 before Dico server 54 stores his or her ratings in its rating database 82. The functions for establishing login sessions are provided by login tool 95, local database 90, and Dico server 54.

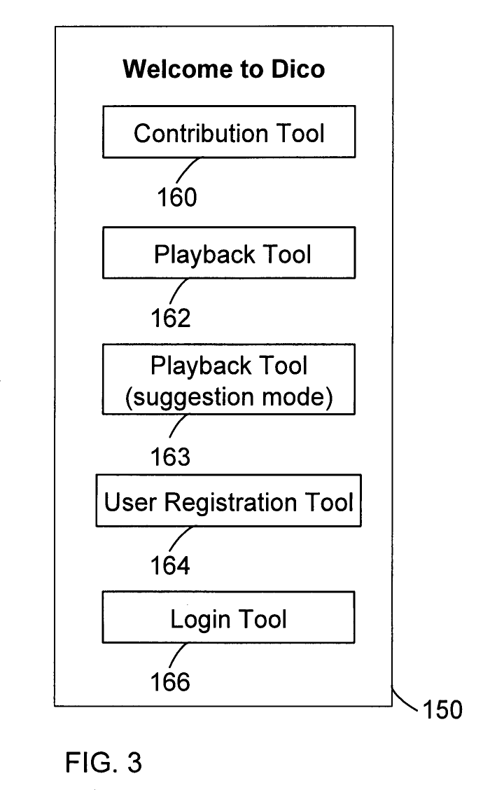

Users are typically presented with an initial welcome web page when they arrive at the web site served by Dico server 54. FIG. 3 shows the typical options Dico provides to its users on this welcome page 150. This web page is generated by Dico server application 70, typically using data from web page database 84. On this page, there are action buttons. Users can press these buttons to start operating various tools 94, 95, 96, and 100 of the Dico system.

“Contribution Tool” button 160 directs the user to begin the process of contributing pronunciations to Dico system 40.

“Playback Tool” button 162 directs the user to begin the process of listening to pronunciations in Dico's corpus 36.

“Playback Tool (suggestion mode)” button 163 directs the user to begin the process of listening to pronunciations suggested by Dico system 40.

“User Registration Tool” button 164 directs the user to begin the process of registering with Dico system 40.

“Login Tool” button 166 directs the user to begin the process of establishing a login session with Dico server 54.

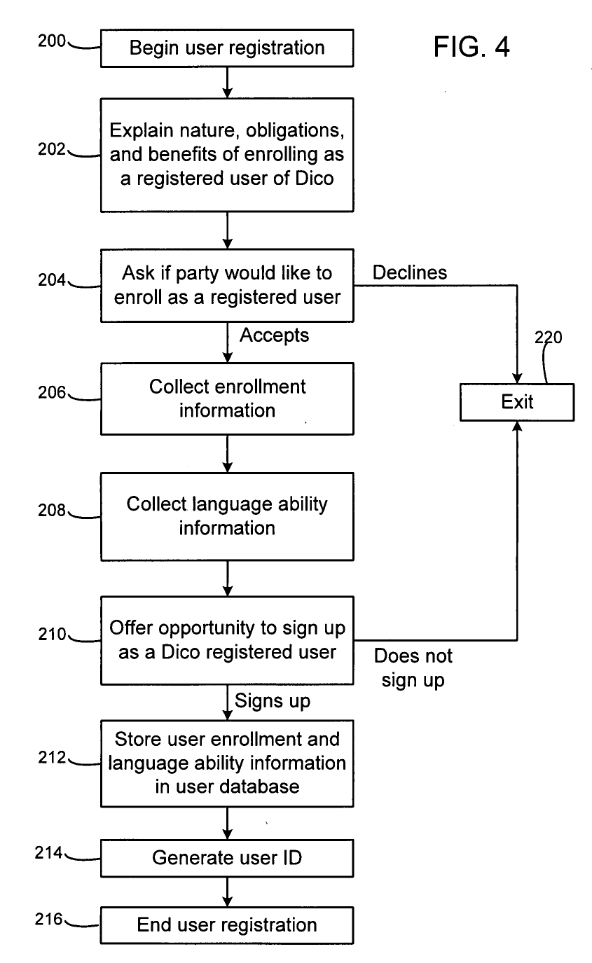

User registration is preferably carried out online. At client 58, the functions necessary to support user registration are provided by user registration tool 94, which is supported by web browser 92. User registration tool 94 works with Dico server application 70. User registration tool 94 is preferably implemented as a series of web pages, displayed in web browser 92. The web pages, together with client-side scripts, are served by Dico server application 70. Dico server application 70 generates the web page by executing instructions on Dico server 54. These web pages and client-side scripts are transmitted to client 58 via data network 50. Optionally, a user registration tool client plug-in can be used in conjunction with the web pages. The web pages use standard techniques, such as HTML, to convey information and instructions to the users. Web browser 92 also uses standard techniques, such as HTTP POST requests, HTTP GET requests, and HTTP XML requests, to transmit information and actions from users to Dico server application 70. The interactions, facilitated by the web pages, between the users and Dico server application 70 effectuate the process depicted in FIG. 4.

FIG. 4 shows a preferred process for user registration. At step 200, an interested party begins the process of user registration, for example, by clicking the “User Registration Tool” action button 164 on the welcome page. The nature, obligations, and benefits of enrolling as a registered user of Dico system 40 are explained to the interested party at step 202. At step 204, the party is asked whether registration is desired. If the party declines registration, the registration process terminates at step 220. If the party accepts registration, registration information, such as a desired unique username, desired password, resident country, etc., is collected at step 206. In addition, his or her language ability, such as his or her first, second, and third languages, etc., is collected at step 208. The party is then offered to sign up with the Dico system 40 as a registered user. Registered users typically have the privileges to contribute and rate pronunciations, while non-registered users do not have these privileges. If the party does not sign up at step 210, user registration terminates at step 220. If the party decides to sign up, he or she can show his or her acceptance by clicking an “I ACCEPT” button. The action causes an HTTP POST request to be transmitted to Dico server 54. The HTTP POST request contains information collected at steps 206 and 208. Dico server application 70, upon receiving the information collected at steps 206 and 208 and the intention of the party, stores the information in user database 76 at step 212. At step 214, Dico server application 70 generates a unique UID for the new user, which is then stored together with the information collected at steps 206 and 208 in user database 76. The UID is used to uniquely identify the user and the information associated with him or her in Dico system 40. The user registration process ends at step 216.

The Login Tool

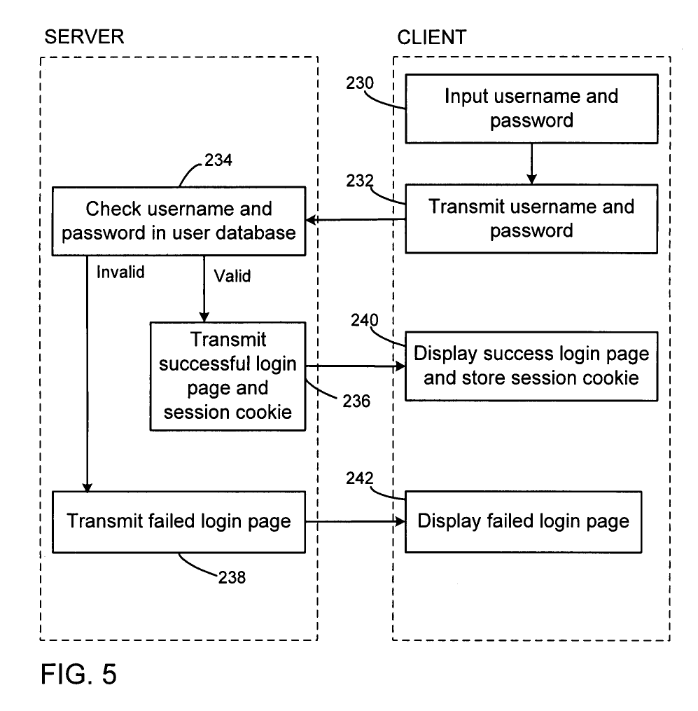

FIG. 5 shows, in a preferred embodiment, the process used by the login tool 95 to establish a login session between Dico server application 70 and web browser 92. The login tool 95 is preferably implemented as a series of web pages, displayed in web browser 92. The web pages, together with client-side scripts, are served by Dico server application 70. Dico server application 70 generates the web page by executing instructions on Dico server 54. These web pages and client-side scripts are transmitted to client 58 via data network 50. Optionally, a login tool client plug-in can be used in conjunction with the web pages. The web pages use standard techniques, such as HTML, to convey information and instructions to the users. Web browser 92 also uses standard techniques, such as HTTP POST requests, HTTP GET requests, and HTTP XML requests, to transmit information and actions from users to Dico server application 70. The interactions, facilitated by the web pages, between the users and Dico server application 70 effectuate the process depicted in FIG. 5.

Users typically arrive at step 230 from welcome screen 150. At step 230, the user inputs his or her username and password on a web page served by Dico server application 70. The username and password are then transmitted to Dico server application 70 at step 232. At step 234, Dico server application 70 receives and performs a validation check of the username and password, i.e., to check if the received username exists in user database and the received password matches the password associated with that username. If the username and password are valid, Dico server application 70 generates a successful login web page and a session cookie, which typically contains at least the UID of the user and an expiry time, which indicates for how long the login session will remain valid. The successful login web page and the session cookie are transmitted to client 58 at step 236. The successful login web page is displayed by web browser 92 at step 240. Web browser 92 also stores the session cookie in its local database 90 at step 240. If the check at step 234 indicates that the supplied username and password pair is invalid, Dico server application 70 generates a failed login web page. The failed login web page is transmitted to client 58 at step 238. The failed login web page is displayed by web browser 92 at step 242.

The Contribution Tool

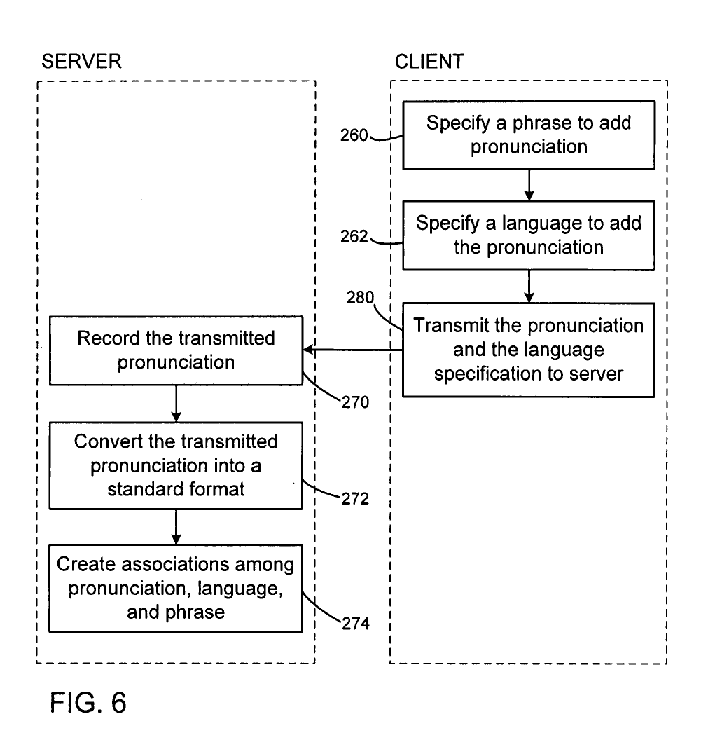

FIG. 6 shows, in a preferred embodiment, the process used by the contribution tool 96 to facilitate contributions from a contributor. Contribution tool 96 is preferably implemented as a series of web pages, displayed in web browser 92. The web pages, together with client-side scripts, are served by Dico server application 70. Dico server application 70 generates the web page by executing instructions on Dico server 54. These web pages and client-side scripts are transmitted to client 58 via data network 50. Optionally, a contribution tool client plug-in can be used in conjunction with the web pages. The web pages use standard techniques, such as HTML, to convey information and instructions to the users. Web browser 92 also uses standard techniques, such as HTTP POST requests, HTTP GET requests, and HTTP XML requests, to transmit information and actions from users to Dico server application 70. The interactions, facilitated by the web pages, between the users and Dico server application 70 effectuate the process depicted in FIG. 6.

Contributors typically first establish a login session with Dico server 54, if they have not already done so before starting the contribution process. Contribution tool 96 determines whether there is a valid login session by checking whether there is a non-expired cookie in local database 90. This check is typically carried out by web browser 92 sending Dico server application 70 the original session cookie web browser 92 received at step 240 of login tool 95. Dico server application 70 then checks whether the session cookie is still valid. If there is no valid login session, a valid login session can be established using login tool 95.

The contributor then uses contribution tool 96 to specify a phrase he or she is going to contribute at step 260. Preferably, contributors use one of the following two methods to specify the phrase:

Method 1 involves selecting a phrase from a list generated by Dico system 40. This list contains a subset of the phrases that need more pronunciation contributions. The list of all phrases needing contributions is called the master list. The master list is generated by considering phrase database 78. Phrases that have yet received one pronunciation contribution are included in the master list. If a phrase has some contributions, but they are rated as low quality by listeners, this phrase is also included in the master list. In a preferred embodiment, the phrase database 78 is populated by several methods. Dico server 54 gleans the phrases from various sources, for examples, newspaper archives, corpuses of web pages, transcripts of the United States Congress, transcripts of courts, etc. This background process of adding phrases to phrase database 78 is performed by Dico daemons 72. In addition, Dico system 40 also monitors the requests made by its listeners. For example, through interacting with playback tool 100, a listener requests “iPod” to be pronounced. In this example, if Dico system 40 does not have the phrase “iPod” in its corpus, “iPod” is considered as a new phrase. Dico server 54 typically collects more information about the new phrase from the listener and then adds it to phrase database 78. For further details of this new phrase addition process, please see the description of playback tool 100 below.

Preferably, Dico server application 70 further selects only a subset of the master list to present to the contributor. In making the selection, it considers the language ability of the contributor, as indicated by him or her during user registration. The information of the language ability of the contributor is stored in the user database 76. For example, a contributor fluent only in French will be presented with a list of French phrases and phrases that are commonly used among French speakers; and they will not be presented with phrases from other languages they do not speak, such as Chinese. Alternatively, a contributor fluent in both English and German will be presented with a list of English and German phrases.

The subset of the master list is presented in a web page. Each phrase has an associated URL link. Clicking the link indicates that the contributor has specified to contribute to the phrase associated with that link.

Method 2 involves directly specifying the phrase the contributor is going to contribute. In this option, the contributor inputs the alphabets of the phrase in a computer-readable encoding, such as ASCII.

This completes the description of the two preferred methods for step 260.

At step 262, after specifying a phrase in step 260, the contributor specifies the language in which the phrase will be pronounced.

Then, at step 280, the contributor uses contribution tool 96 to transmit a pronunciation to Dico server application 70. This is preferably accomplished by using one of various methods including, but not limited to, the followings:

Method 1: the contributor uploads a media file to Dico server 54. At the time of upload, the media file is already resident in the contributor's computer, having been previously generated by media creation software 102. One example of such software is iLife '06, manufactured by Apple Incorporated. It can be used by the contributor to capture synchronized video and audio materials from a computer-attached camera 112 and a computer-attached microphone 114. For example, the contributor can utter the phrase in front of camera 112 and microphone 114, and media creation software 102 will capture the audio and video materials of the utterance. Multimedia peripheral devices, such as camera 112 and microphone 114, are readily available to the contributor. For example, they are built-in features of MacBook laptop computers, manufactured by Apple Incorporated. In addition to capturing video and audio materials from computer-attached devices, media creation software 102 can also import video and audio materials recorded previously on a portable audio and video capturing device, such as Sony's HandyCam HDR-FX7 or Canon's PowerShot SD550. Importing is typically carried out by connecting the portable device to client 58 using a data cable or wirelessly. Media creation software 102 then communicates with the device to extract suitable audio and video materials from the device.

The contributor typically uploads a media file containing a pronunciation pronounced by himself or herself, but can also upload a media file containing a pronunciation pronounced by another person, or persons, or that the pronunciation is computer-generated.

One skilled in the art will appreciate that there are a multitude of ways to generate, import, and process multimedia files. In general, media creation software 102 creates or imports audio and video materials and stores them in a media file. The media file is typically stored in a format accepted by Dico server application 70. Examples of such media file format are audio and video formats from the Moving Picture Experts Group (“MPEG”), Audio Video Interleave (“AVI”), Microsoft's Windows Media Video (“WMV”) format, and file formats generated by Apple Incorporated's QuickTime software.

The media file does not need to contain both video and audio materials. It may contain only audio materials, created similarly as described above by media creation software 102. Examples of audio only formats are MPEG-1 Audio Layer 3 (“MP3”), Waveform Audio Format (“WAV”), Windows Media Audio (“WMA”), and Advanced Audio Coding (“AAC”). Indeed, the audio content is important to the objects of Dico system 40. The media file can also be textual encoding in phonetic symbols, such as the IPA. It can also be computer source code or computer executable code, which, when executed in a suitable execution environment, causes client 58 to at least produce an audible pronunciation via audio speaker 110.

To facilitate the selection of the media file, contribution tool 96 provides a file system browser for the contributor to select a file from their computer. Upon selecting a file from his or her computer, the contributor requests the file to be uploaded to Dico server 54 at step 280. Dico server application 70 then records the uploaded media file in temporary storage at step 270.

Method 2: the contributor and Dico server 54 first establish an audio (and optionally, video) connection that offer the contributor an impression that the connection is real time. The contributor then utters the phrase into a suitable input component of the device he or she used to make that the connection. The connection can be an audio only telephone connection, such as a traditional circuit-switched telephone connection, a Voice-over-Internet-Protocol (“VOIP”) telephone connection, or a mobile phone connection. Preferably, Dico server 54 makes a telephone call to the contributor after step 262, wherein the telephone number of the contributor is typically supplied during user registration step 206. Alternatively, the contributor can initiate the phone call to Dico server 54, whose telephone number is typically publicly known, or is presented to the contributor during user registration, or is presented to the contributor as part of step 280. In a preferred embodiment, the contributor uses a telephone to receive the call from Dico server 54. Upon connection, the contributor utters the phrase into the microphone of the telephone. Dico server 54 captures the pronunciation in real time, and records it in temporary storage at step 270. It is possible that a video phone is used to capture video materials as well as the audio pronunciation.

The entire call making, connection, and audio (and optionally, video) conversation can be managed on Dico server 54 by a telephony software, such as Asterisk, an open-source private branch exchange (“PBX”) software. Another example is the Skype telephone service, operated by EBay Incorporated. Using the Skype service, Dico server 54 can make voice connections with tradition telephones.

Another type of connection that appears to be a real-time connection is provided by instant messaging services. Examples of such instant messaging services are Microsoft's MSN Messenger, Yahoo's Yahoo! Messenger, AOL's Instant Messaging, and Google's Gtalk. All of these examples allow their users to establish a seemingly real-time connection for voice (and optionally, video) chats. A connection can be established between Dico server 54 and the contributor by using one of these instant messaging services. Dico server 54 can send to the contributor an instant message, in text, audio or video, such as “Please pronounce such-and-such phrase in such-and-such language” to the contributor. Typically, the contributor and Dico server 54 are identified in the instant messaging system with their respective user identity numbers or usernames registered with the instant messaging system. The contributor's instant messaging user identity number or username is typically supplied during user registration step 206. The user identity number or username of Dico server 54 is typically publicly known, or is presented to the contributor during user registration, or is presented to the contributor as part of step 280. After receiving the instant message from Dico server 54, the contributor then utters the phrase into microphone 114. Dico server 54 captures the audio (and optionally, video) materials of the pronunciation in real time, and records them in temporary storage at step 270.

Method 3: A client plug-in component, such as an ActiveX control or a Flash application running in a browser, can be used to directly control microphone 114 (and optionally, camera 112). Flash is a software technology manufactured by Adobe System Incorporated. ActiveX control is a software technology manufactured by Microsoft Corporation. Such plug-in component is typically a part of contribution tool 96. Together with contribution tool 96, the plug-in component is used to control when microphone 114 (and optionally, camera 112) begins and ends capturing. The plug-in component may also be used to display instructions for the contributor on the browser window and to transmit the captured audio (and optionally, video) materials to Dico server 54. Dico server 54 then records the pronunciation in temporary storage at step 270. For example, a Flash browser application, in conjunction with a Flash Media Server (also manufactured by Adobe System Incorporated), running in Dico server 54, can be used to establish a seemingly real-time connection between the client and Dico server 54. In this case, Dico server 54 receives the pronunciation in almost real-time and record the pronunciation in temporary storage.

This completes the descriptions of the various methods for steps 280 and 270.

At step 272, Dico server application 70 converts the pronunciation recorded at step 270 to a standard format for its phrase database 78. All phrases are preferably stored in a common format, making it more convenient to perform maintenance and analysis. This process is called normalization. The format can be one of the common media formats mentioned above, or a proprietary format. At step 274, the normalized audio (and optionally, video) materials are then associated with the phrase specified at step 260 and with the language specified at step 262. This association, as well as the contributed pronunciation media materials, are then stored in database 78 and 80. For details on the organization of the databases, please see further description in a later section.

Most pronunciations are public and can be rated by listeners. However, the contributor can specify his or her pronunciation to be private. This means the pronunciation will not be listed publicly in playback tool 100. Listeners typically access a private pronunciation directly by a URL, which points to a web page containing the pronunciation. The URL is preferably provided by Dico server application 70 to the contributor of the private pronunciation. The contributor can then distribute the URL discreetly to his or her desired listeners. In addition, the contributor may prohibit his or her pronunciation to be rated by anyone. This is called a no-rate pronunciation. The properties private and no-rate are independent of each other.

An example of a private and no-rate pronunciation would be a person's name. A person records his or her pronunciation of his or her own name in Dico's corpus 36. He or she only wants to distribute this pronunciation to his or her friends who are interested to learn the correct pronunciation of his or her name. In this case, there is almost no reason for anyone to rate the pronunciation.

One skilled in the art will appreciate that various steps 260, 262, 280, 270 and 272 can be omitted or rearranged or adapted in various ways. For example, the contributor can first upload the media file to Dico server 54, and then specify what phrase it was that he has uploaded. In general, the contributor goes through steps to associate with a phrase a media file containing the audio (and optionally, video) materials of a pronunciation.

One skilled in the art will also appreciate that the steps of 260, 262, 270, and 280, can be used in various environments other than the web-oriented method described. For example, a contributor can specify a phrase and its language in an electronic mail, attach a media file to the mail, and send the mail to Dico server 54. The media file contains the audio (and optionally, video) materials of the pronunciation of that phrase.

Using the contribution process depicted FIG. 6, Dico system 40 is able to efficiently receive pronunciations from its contributors.

The Playback Tool

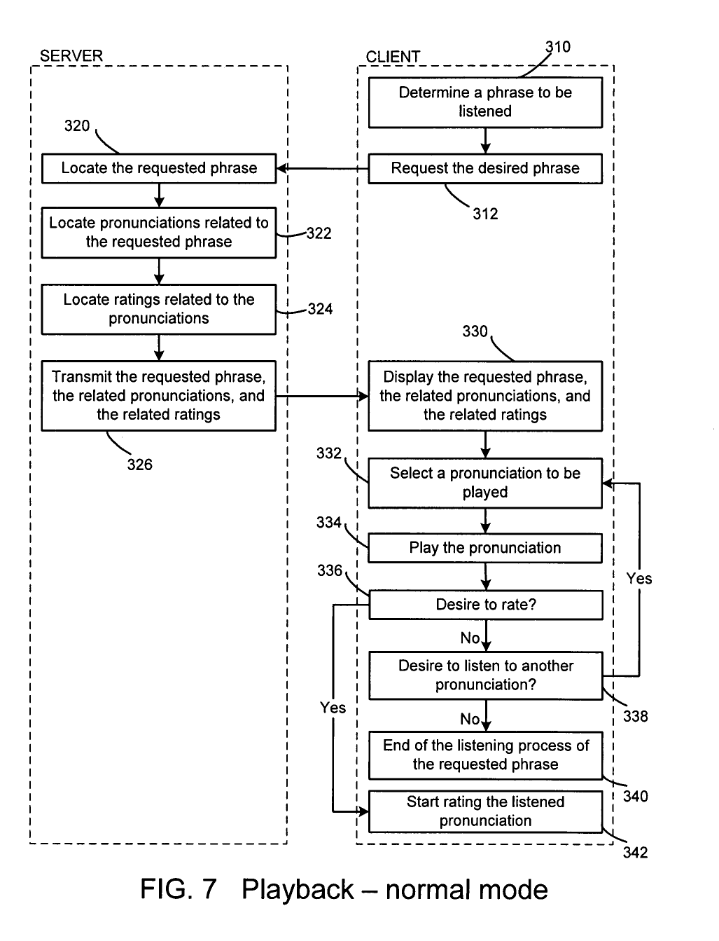

FIG. 7 shows, in a preferred embodiment, the process used by playback tool 100 to play back pronunciations to listeners in normal mode. Playback tool 100 is preferably implemented as a series of web pages, displayed in web browser 92. The web pages, together with client-side scripts, are served by Dico server application 70. Dico server application 70 generates the web page by executing instructions on Dico server 54. These web pages and client-side scripts are transmitted to client 58 via data network 50. Optionally, a playback tool client plug-in can be used in conjunction with the web pages. Typical playback tool client plug-ins are Flash Player, a client software component manufactured by Adobe System Incorporated and designed to execute Flash applications, and QuickTime, manufactured by Apple Incorporated. The web pages use standard techniques, such as HTML, to convey information and instructions to the users. Web browser 92 also uses standard techniques, such as HTTP POST requests, HTTP GET requests, and HTTP XML requests, to transmit information and actions from users to Dico server application 70. The interactions, facilitated by the web pages, between the users and Dico server application 70 effectuate the process depicted in FIG. 7.

At steps 310 and 312, the listener specifies a phrase that she or he wants to hear it pronounced, and makes a request to Dico server 54. Similar to contribution tool 96, playback tool 100 provides a number of alternatives in which the listener can specify the phrase. The listener can use various methods including, but not limited to, the followings:

Method 1: The listener inputs a desired phrase directly in a text box in a web page of playback tool 100, and then clicks a “Search Pronunciations” button on the web page to cause web browser 92 to request the desired web page containing the desired pronunciations.

Method 2: The listener is directed to the desired pronunciations directly by a URL. The URL can be transmitted to Dico server 54 as an HTTP GET request.

Method 3: The listener specifies the phrase using computer-readable alphabets in an electronic mail and sends the mail to Dico server 54.

Method 4: The listener specifies the phrase using computer-readable alphabets in a Short Messaging Service (“SMS”) message and sends the message, typically from a mobile phone, to Dico server 54.

Method 5: The listener makes a telephone call to Dico server 54. After connection is established, the listener inputs the phrase using the keypad of his or her telephone.

Method 6: The listener sends a textual instant message to Dico server 54 using an instant messaging service. The instant message contains the desired phrase, encoded in computer-readable alphabets.

This completes the description for the various methods of steps 310 and 312.

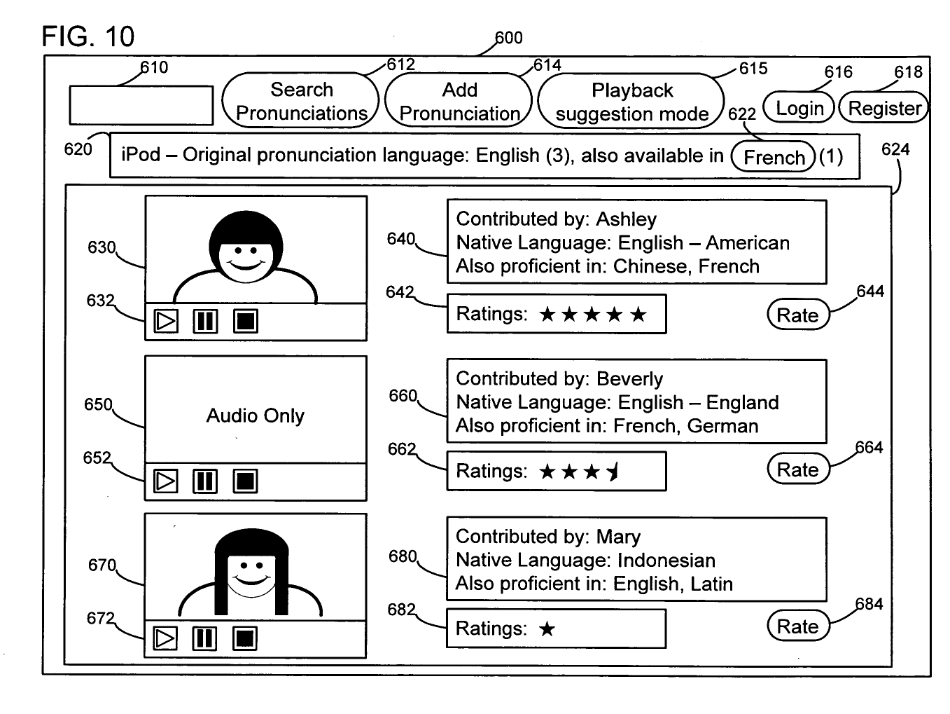

Upon receiving the request from the listener, Dico server 54 locates the phrase, its pronunciations, and the ratings of those pronunciations in its databases 78, 80, and 82 at steps 320, 322, and 324. In an embodiment where Dico is a web application, Dico server application 70 assembles these materials into a web page. This web page is transmitted to web browser 92 at step 326. FIG. 10 depicts the key elements of one such web page 600. Element 620 indicates the phrase requested by the listener. In this example, it is “iPod”. It preferably also indicates the language of the pronunciations. In this example, the language is English. Element 622 indicates alternative languages in which some contributions are made. Element 622 is preferably a collection of at least one URL link that direct the browser to web pages listing the phrase in the respective languages.

Element 624 contains the list of pronunciations that Dico server application 70 locates at step 322. This is called the pronunciation list. In this example the pronunciations are contributed by Ashley, Beverly, and Mary. Elements 630, 632, 640, and 642 contain information about a pronunciation contributed by Ashley. Element 630 is a preview of the video and audio materials contributed by Ashley. Element 632 allows the listener to control the playback of the video and audio materials. Typically, elements 630 and 632 are part of a playback tool client plug-ins, such as the Flash Player. Element 640 indicates that the pronunciation was contributed by Ashley, and she speaks English in the American accent natively. It also indicates the other languages in which Ashley is proficient in. The language ability of Ashley is collected during step 208 in the user registration process. Element 642 provides a summary of the ratings received for this pronunciation. It can contain a breakdown of the ratings in terms of accuracy, helpfulness and likeableness. It can also contain summaries of system statistics such as the total number of times this pronunciation has been played back.

Elements 650, 652, 660, and 662 contain information about another pronunciation, contributed by Beverly. Note that this contribution is an audio only contribution.

Elements 670, 672, 680, and 682 contain information about another pronunciation, contributed by Mary.

As depicted in web page 600, Dico server application 70 can arrange the pronunciations according to their quality, for instance by sorting the pronunciation in descending order of a quality measure. One quality measure can be calculated as follows for each pronunciation:

First, an average measure of a criterion rated in a binary system can be calculated as the percentage of ratings rated in the positive. Criterion such as accuracy can be handled in this manner. For example, if Beverly's pronunciation for “iPod” has three accuracy ratings, which are:

Accuracy rating 1: YES

Accuracy rating 2: YES

Accuracy rating 3: NO

The average accuracy is therefore ⅔=0.667=66.7%.

Second, an average measure of a criterion rated in a numerical scale can be calculated as the sum of all numerical ratings divided by the number of ratings, and further divided by the maximum of the numerical scale. Criteria such as helpfulness and likeableness can be handled in this manner. For example, if Beverly's pronunciation for iPod has four helpfulness ratings, which are:

Helpfulness rating 1: 5 stars

Helpfulness rating 2: 2 stars

Helpfulness rating 3: 3 stars

Helpfulness rating 4: 5 stars

The average helpfulness is therefore (5+2+3+5)/4/5=0.75.

In addition, if Beverly's pronunciation for iPod has two likeableness ratings, which are:

Likeableness rating 1: 5 stars

Likeableness rating 2: 4 stars

The average likeableness is therefore (5+4)/2/5=0.9.

Third, an overall quality measure of a pronunciation can be calculated as a weighted average of the average measure for each rating criterion. For example, a weight of one-half can be assigned to the accuracy criterion, a weight of one-fourth can be assigned to the helpfulness criterion, and a weight of one-fourth can be assigned to the likeableness criterion. In this example, the average quality of Beverly's pronunciation is 0.667×0.5+0.75×0.25+0.9×0.25=0.746.

Preferably, accuracy is the most important criterion. Consequently, it is typically given a higher weight. However, any combination of weights, from 0 to 1, can be used to calculate the average quality.

Yet another option is to assign higher importance to rating received more recently. A higher importance for the recently received ratings can be capture in a average quality measure by giving a higher weighting for recently received ratings than to older ratings. Using such quality measure, or one calculated similarly, for each pronunciation in its corpus, Dico server application 70 can then arrange the pronunciations in descending order of a quality in web page 600.

Listener's web browser 92 then displays web page 600 to the listener at step 330. At step 332, the listener selects which pronunciation to play. The listener does so by clicking on element 632, 652, or 672 to play the desired pronunciation. In this embodiment, the playback at step 334 is achieved by streaming of audio (and optionally, video) content from Dico server 54, and outputting the sound on audio speaker 110. After the pronunciation is heard, the corresponding “Rate” button, element 644, 664, or 684, becomes enabled. The listener decides whether to rate the pronunciation at step 336. If the listener chooses to do so, he or she can click the corresponding “Rate” button to start operating rating tool 98 in step 342. If not, the listener can choose to listen to another pronunciation in step 338. In this case, the listener will repeat steps 332, 334, 336, and 338. Otherwise, the process of playback tool 100 ends at step 340.

The other elements on web page 600 provide further functions to the listener. Elements 610, 612, 614, 615, 616, and 618 allow the listener to specify another phrase to listen to, or to navigator to other tools of the Dico system 40. The listener can type in another phrase in textbox 610 and click “Search Pronunciations” button 612 to find another phrase. The listener can contribute his or her own pronunciations to Dico's corpus 36 by clicking “Add Pronunciation” button 614. This will start the operation of contribution tool 96, in which the listener will then take the role of a contributor. The listener can choose to listen to pronunciations suggested by Dico server application 70 by clicking “Playback suggestion mode” button 615, which will start the operation of playback tool 100 in suggestion mode (This mode is described in at later section). The listener can choose to login to establish a login session with Dico server by clicking “Login” button 616, which will start the operation of login tool 95. The listener can choose to register with the Dico system by clicking the Register button 618, which will start the operation of user registration tool 94.

If a suitable phrase that matches the inputted phrase (inputted at step 310) is not found at step 320, the inputted phrase is considered new. The listener is preferably asked whether he or she would like to add the inputted phrase to Dico's corpus 36. Dico server application 70 typically collects more information about the new phrase at this point, such as the language of the phrase. If the listener agrees to add this phrase to corpus 36, he or she can supply the additional information. Dico server application 70 then stores the new phrase and its addition information in phrase database 78. This new phrase does not yet have any pronunciation contribution associated with it.

One skilled in the art would appreciate that the format of the material transmitted in step 326, and the way it is presented in steps 330, 332, 334, 336, and 338 depends on the methods chosen by the listeners in steps 310 and 312. For example, if the chosen method is method 3, the desired pronunciations and all related information can be presented via a reply electronic mail as a text message with the pronunciations attached as media files. If the chosen method is one of methods 4 and 5, the pronunciations can be transmitted to the listener via a telephone connection. If the chosen method is method 6, the pronunciations can be transmitted to the listener via the instant messaging connection. Even when the chosen method is method 1 or 2, the playback can be adapted in various ways. For examples, the playback can be arranged as a download of a media file to the listener's computer, instead of streaming as described above. Or the playback of the top quality pronunciation be “auto-start”, i.e., the pronunciation is played back immediately upon the display of web page 600, without the need for the listener to click the play button in element 632. Or Dico can concatenate the top three pronunciations to be played back in one continuous audio (and optionally, video) clip without any intervention from the listener. Or the pronunciations may be played back at a speed different from the original speed in the contributions. Or Dico can concatenate some pronunciations from male contributors and some from female contributors.

In addition to being arranged in descending order of quality, the pronunciations can be arranged in any other ways. For example, the list may be arranged in a reverse chronological order, with the most recent contributions arranged at the top. Or the list can be arranged by only parts of the ratings, such as only by likeableness. Or the list can be arranged by the gender of the contributors. Or the list can be arranged in a random order. Or in any other ways Dico allows its listeners to specify.

Playback tool 100 has another mode of operation in that its selection of pronunciations in the pronunciation list (element 624 in FIG. 10) is different from the process described above. It is called the suggestion mode. It is so named to give the notion that Dico system 40 suggests certain pronunciations for the user to listen to. Dico system 40 uses the suggestion mode to encourage more rating inputs for selected pronunciations in its corpus 36, especially from users who claims to speak the languages corresponding to the phrases in its corpus 36.

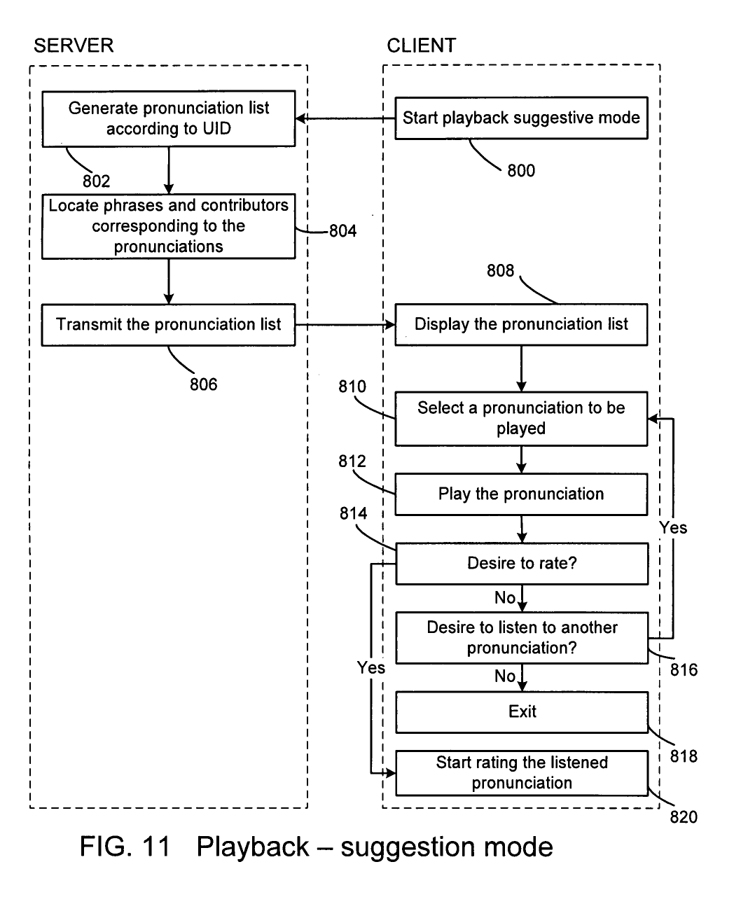

For an embodiment where Dico system 40 is a web application, FIG. 11 depicts the process of playback tool 100 operating in suggestion mode. At step 800, a user begins operating playback tool 100 in suggestion mode. Users can arrive at step 800 by clicking the “Playback Tool (suggestion mode)” button 163 on welcome page 150. Or Dico server application 70 can direct a user to step 800 after he or she has finished operating any one of tools 94, 95, 96, 98, and 100.

Users typically first establish a login session with Dico server 54, if they have not already done so before starting the suggestion mode process. Playback tool 100 determines whether there is a valid login session by checking whether there is a non-expired cookie in local database 90. This check is typically carried out by web browser 92 sending Dico server application 70 the original session cookie web browser 92 received at step 240 of login tool 95. Dico server application 70 then checks whether the session cookie is still valid. If there is no valid login session, a valid login session can be established by login tool 95.

In suggestion mode, an important difference from the normal mode is that the user does not get to specify a phrase that he or she would like to hear, as it is done at steps 310 and 312. Instead, Dico server application 70 generates a pronunciation list at step 802. Preferably, Dico server application 70 includes pronunciations that the user can meaningfully rate, namely those pronunciations for phrases that are in languages the user knows. Dico server application 70 is able to do so because it has already collected information about the language ability of the user at step 208 during user registration. Dico server application 70 also considers the ratings, received so far, for each pronunciation in Dico's corpus 36. For example, pronunciations with none or few ratings are favored to be included in the list. Pronunciations that have inconsistent ratings are also favored to be included in the list.

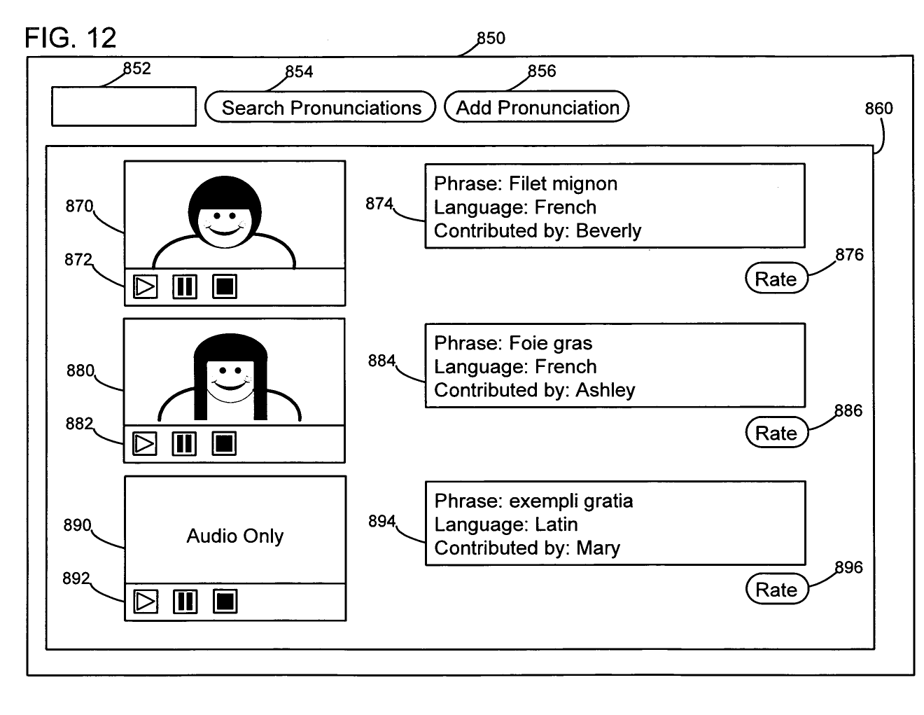

At step 804, Dico server application 70 gathers the corresponding data about the pronunciations in the list, namely their phrases and their contributors. In an embodiment where Dico is a web application, Dico server application 70 assembles these materials into a web page. This web page is transmitted to web browser 92 at step 806. FIG. 12 depicts the key elements of one such web page 850.

Element 860 contains the list of pronunciations that Dico server application 70 locates at step 802. This is called the pronunciation list. In this example the pronunciations are contributed by Beverly, Ashley, and Mary. Elements 870, 872, and 874 contain information about the pronunciation of “Filet mignon” contributed by Beverly. Element 870 is a preview of the video and audio materials contributed by Beverly. Element 872 allows the user to control the playback of the video and audio materials. Typically, elements 870 and 872 are part of a playback tool client plug-ins, such as the Flash Player. Element 874 indicates that the pronunciation is one of the pronunciations available for the French phrase “Filet mignon”, and that it was contributed by Beverly.

Elements 880, 882, and 884, contain information about a pronunciation of the French phrase “Foie gras”, contributed by Ashley.

Elements 890, 892, and 894, contain information about a pronunciation of the Latin phrase “exempli gratia”, contributed by Mary.

In this example, one of the reasons French and Latin phrases are presented is that the user has claimed that he or she knows Latin and French at step 208 of the user registration process.

The user's web browser 92 displays web page 850 to the user at step 808. At step 810, the user selects which pronunciation to play. The user does so by clicking on element 872, 882, or 892 to play the desired pronunciation. In this embodiment, the playback at step 810 is achieved by streaming of audio (and optionally, video) content from Dico server 54, and outputting the sound on audio speaker 110. After the pronunciation is played, the corresponding “Rate” button, element 876, 886, or 896 becomes enabled. The user decides whether to rate the pronunciation at step 814. If the user chooses to do so, he or she can click the corresponding “Rate” button to start operating rating tool 98 in step 820. If not, the user can choose to listen to another pronunciation in step 816. In this case, the user will repeat steps 810, 812, 814, and 816. Otherwise, the process of suggestion mode of playback tool 100 ends at step 818.

The other elements on web page 850 provide further functions to the user. Elements 852 and 854 allow the user to specify another phrase to listen to, in effect starting the original playback tool 100 at step 310. The user can type in another phrase in textbox 852 and click “Search Pronunciations” button 854 to find another phrase. The user can contribute his or her own pronunciations to Dico's corpus 36 by clicking “Add Pronunciation” button 856. This will start the operation of contribution tool 96, in which the user will then take the role of a contributor.

The Rating Tool

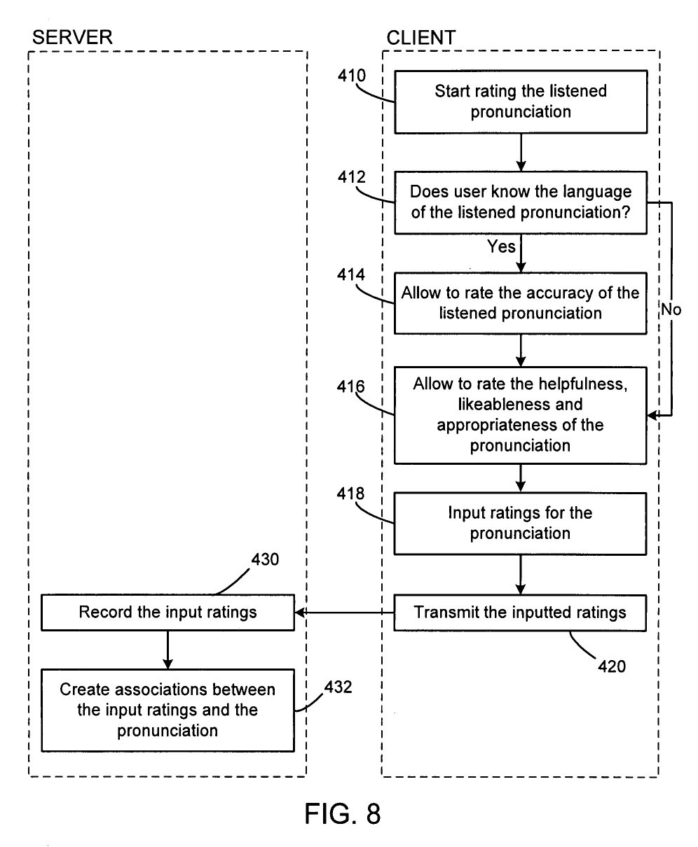

FIG. 8 shows, in a preferred embodiment, the process used by rating tool 98 to facilitate a listener to enter a rating for a pronunciation. Rating tool 98 is preferably implemented as a series of web pages, displayed in web browser 92. The web pages, together with client-side scripts, are served by Dico server application 70. Dico server application 70 generates the web page by executing instructions on Dico server 54. These web pages and client-side scripts are transmitted to client 58 via data network 50. Optionally, a rating tool client plug-in can be used in conjunction with the web pages. The web pages use standard techniques, such as HTML, to convey information and instructions to the users. Web browser 92 also uses standard techniques, such as HTTP POST requests, HTTP GET requests, and HTTP XML requests, to transmit information and actions from users to Dico server application 70. The interactions, facilitated by the web pages, between the users and Dico server application 70 effectuate the process depicted in FIG. 8.

Listeners typically first establish a login session with Dico server 54, if they have not already done so before starting the rating process. Rating tool 98 determines whether there is a valid login session by checking whether there is a non-expired cookie in local database 90. This check is typically carried out by web browser 92 sending Dico server application 70 the original session cookie web browser 92 received at step 240 of login tool 95. Dico server application 70 then checks whether the session cookie is still valid. If there is no valid login session, a valid login session can be established by login tool 95.

Step 410 starts the process of rating. At step 412, rating tool 98 determines whether the listener knows the language in which the pronunciation was recorded in. Rating tool 98 uses information from the user database 76 to determine the language ability of the listener, as he or she has inputted during user registration with Dico system 40. If the listener knows the language of the pronunciation, rating tool 98 displays an interface for the listener to rating for the accuracy of the pronunciation at step 414. Preferably, this interface allows the listener to rate using a binary scale—whether the pronunciation is accurate or not. One skilled in the art will appreciate that a numerical scale, such as a five-star scale, ten-star scale, or a real number scale, can also be used. At step 416, rating tool 98 further displays interfaces for rating the pronunciation on various other criteria. Examples of such criteria are helpfulness and likeableness. Typically, these are rated on a numerical scale such as a five-star scale. Preferably, the pronunciation is also rated on its appropriateness or decency. This criterion is typically rated in a binary scale—whether the materials are decent, or not.

At step 418, the listener inputs the ratings for the above criteria. The inputted ratings are transmitted to Dico server 54 at step 420.

Dico server application 70 records the ratings in step 430 in temporary storage. In step 432, Dico server application 70 creates an association between the just recorded ratings and the pronunciation to which the ratings refer to. This information of the association as well as the ratings themselves are stored in rating database 82.

Preferably, Dico server application 70 also records the UID of the listener to indicate that this listener has rated the pronunciation. This can be used to control subsequent attempts to rate the same pronunciation by the same listener, such as prohibiting him or her to do so, or allow him or her to update the old rating with a new one.

Organization of the Databases

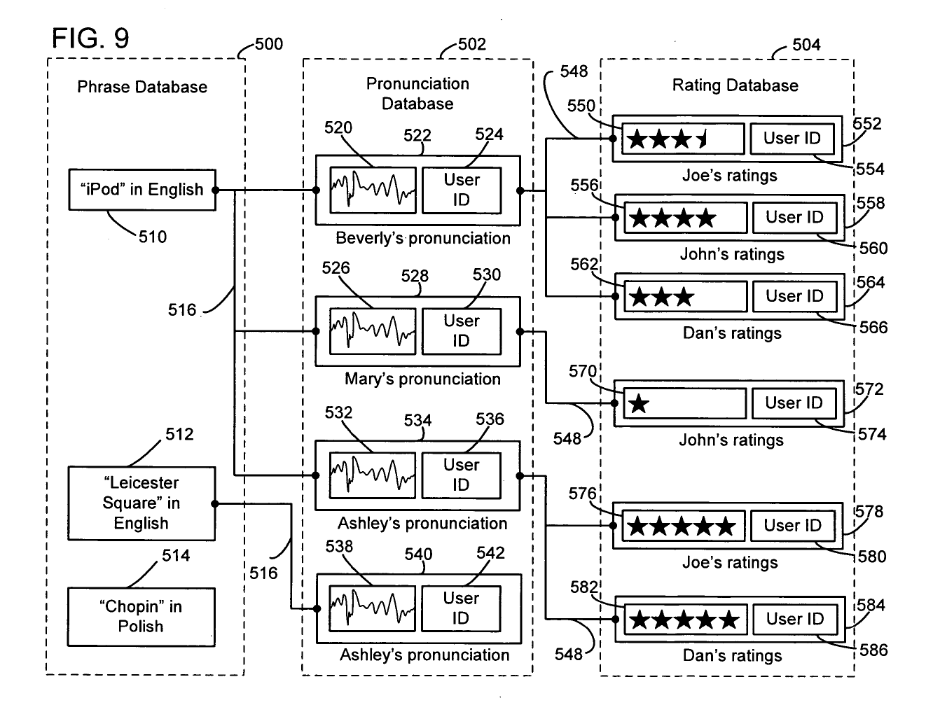

A relational database management system (“RDBMS”), such as Oracle's Database 10g, Microsoft's SQL Server, IBM's DB2, and MySQL, is preferably used to store and organize the data received and derived by Dico server 54. FIG. 9 depicts the relationships of the key pieces of data in databases 76, 78, 80, and 82.

FIG. 9 shows the three key databases of Dico system 54—the phrase database 500, the pronunciation database 502, and the rating database 504.

Phrase database 500 contains phrase entries for the phrases in the corpus. Each entry corresponds to one phrase in Dico's corpus 36. Three entries are shown as example in FIG. 9—“iPod” 510, “Leicester Square” 512, and “Chopin” 514. Each phrase entry includes the followings:

1. the phrase itself, encoded in computer-readable alphabets, such as the ASCII code of the letters of the phrase.

2. the language of the phrase.

Preferably, each phrase entry also includes a unique identity number, called the Phrase ID (“PhID”) to uniquely identify the phrase entry.

Pronunciation database 502 contains pronunciation entries for pronunciations contributed by contributors of Dico system 40. Each entry corresponds to one pronunciation contributed by one contributor. Four pronunciation entries 522, 528, 534, and 540 are shown as example in FIG. 9. Three of them are entries 522, 528, and 534 for “iPod”. One is an entry 540 for “Leicester Square”. “Chopin” does not yet have a contributed pronunciation in Dico's corpus 36. Each pronunciation entry includes the followings:

1. The media content of the contributed pronunciation. This can be a block of binary data stored in the RDBMS. Or, it can be a link referencing a file resident in the Dico server. The media materials are represented as elements 520, 526, 532, and 538 in FIG. 9.

2. the UID of the contributor. The UIDs of the contributors are represented as elements 524, 530, 536, and 542 in FIG. 9.

Preferably, each pronunciation entry also includes a unique identifier, called the Pronunciation ID (“PrID”) to uniquely identify the pronunciation entry.

The pronunciation entries are associated with their respective phrases (links 516). Preferably, this is accomplished by storing the corresponding PhID in the pronunciation entry.

Rating database 504 contains rating entries for ratings inputted by listeners of the Dico system. Each entry corresponds to a set of ratings for one pronunciation, inputted by one listener. Six rating entries 552, 558, 564, 572, 578, and 584 are shown as example in FIG. 9. Each rating entry includes the followings:

1. the ratings for one pronunciation by one listener. The ratings contain all the ratings for a multitude of criteria, such as accuracy, helpfulness, and likeableness inputted by one listener. The ratings are represented as elements 550, 556, 562, 570, 576, and 582 in FIG. 9.

2. the UID of the listener. The UIDs of the listener are represented as elements 554, 560, 566, 574, 580, and 586 in FIG. 9.

Preferably, each rating entry also includes a unique identifier, called the Rating ID (“RID”) to uniquely identify the rating entry.

The rating entries are associated with their respective pronunciations (links 548). Preferably, this is accomplished by storing the corresponding PrID in the rating entry.

Evolution of the Dico Corpus

Dico system 40 achieves its self-extending and self-improving characteristics through interactions with users. First and foremost, Dico system 40 receives pronunciation contributions for the phrases by interacting with users via contribution tool 96. At the same time, by interacting with users via playback tool 100, Dico system 40 receives requests for phrases to be pronounced. If a phrase that is not currently included in corpus 36 is requested, Dico system 40 recognizes it as a new phrase and adds the phrase to corpus 36. This allows Dico system 40 to quickly gather and expand the collection of phrases of interests in corpus 36.

Being easy and convenient to contribute, Dico allows an ordinary Internet user who can read and speak at least one language to become a contributor immediately. Also, multiple contributors can contribute to the same phrase, and Dico system 40 can continue to receive new pronunciations for each phrase. Some of them can be of higher quality than the existing pronunciations. Dico system 40 also use contribution tool 96 to guide contributors to contribute pronunciations that are most needed to enhance the quality of corpus 36.

Users are also encouraged to rate the pronunciations for each phrase. Playback tool 100 and rating tool 98 provide a convenient way for users to rate the pronunciations after they have listened to them. Dico attracts users who want to learn to pronounce certain phrases by providing them with the contributed pronunciations. This in turns attracts more ratings for the pronunciations. Also, suggestion mode of playback tool 100 encourages users to listen to and rate a selected set of pronunciations. This set of pronunciations is selected by Dico system 40. In particular, Dico system 40 selects pronunciations according to the language ability of the user, so users who knows a language are presented with pronunciations in that language in the suggestion mode. The users with knowledge in the language are able to provide meaningful accuracy ratings for the pronunciations.

With plenty of contributed pronunciations and plenty of ratings, Dico system 40 can reliably estimate the quality of each contributed pronunciation, new and old alike. Thus, some pronunciations can be identified as better. One way this information can be fed back to benefit the users is to arrange the higher quality pronunciations at the top of the pronunciation list on web page 600, making it easier for users to find high quality pronunciations for the phrases they are interested in.

In addition, Dico server collects system statistics during its operations. Example of such system statistics are number of times each phrase is heard, number of times each phrase is rated, and IP addresses of its requests. By analyzing the data contained in databases 76, 78, 80, and 82 together with system statistics, Dico server is able to derive further statistics. Examples of such statistics are the number of times all the phrases contributed by the same contributor are heard, number of phrases contributed by the same contributor, overall quality of each contributor, popularity of certain phrases in certain region in the world, and popularity of each contributor.

These statistics can then be used in arranging and selecting the pronunciations in the pronunciation list in web page 600.

Although the present invention has been described in terms of various embodiments, it is not intended that the invention be limited to these embodiments. Modification within the spirit of the invention will be apparent to those skilled in the art. For example, a more generalized client-server approach, utilizing server software and client software that communicate directly over the Internet using other standard protocols, such as the transport control protocol (“TCP”), can be used instead of the web-oriented approach described. In such approach, the server software does not need to support HTTP request, or output HTML web page. The client software renders a user interface for tools 94, 95, 96, 98 and 100 without using a web browser. Users interact directly with the user interface components of such client software. Also, a contributor can choose to contribute pronunciations by recording them in a compact disc (“CD”) and sending it via post to the entity that operates Dico server 54.

In general, Dico achieves the generation of a high quality pronunciation corpus by gathering pronunciations, making them available to Dico's users, and allowing users to rate them. Also, with the ratings, Dico discerns the quality of the contributions, and Dico also makes the information about the quality of each pronunciation available to Dico's users to assist them in finding high quality pronunciations in corpus 36.

We claim:

1. A method for accessing and generating a pronunciation corpus of phrases, comprising:
under control of one of a plurality of client systems, carrying out, independently of other client systems, at least one action selected from a set including:
sending to a server system a pronunciation for a phrase in the corpus;
sending to the server system a request for at least one pronunciation for at least one phrase in the corpus; and
receiving from the server system the at least one requested pronunciation,
under control of the server system, carrying out, in no particular order, at least one action selected from a set including:
receiving from a client system a pronunciation for a phrase in the corpus;
receiving from a client system a request for at least one pronunciation for at least one phrase in the corpus; and
sending to the requesting client system the at least one requested pronunciation.

2. The method of claim 1 wherein the set, under control of a client system, includes playing back a received pronunciation.

3. The method of claim 1 wherein the set, under control of a client system, includes sending to the server system a phrase for inclusion in the corpus;

4. The method of claim 1 including, under control of the server system, receiving a phrase for inclusion in the corpus, whereby the corpus can be expanded continuously with new phrases and new pronunciations received from the client systems.

5. The method of claim 1 wherein the set, under control of a client system, includes sending to the server system at least one rating for the at least one received pronunciation.

6. The method of claim 1 including, under control the server system, receiving at least one rating for the at least one sent pronunciation.

7. The method of claim 1 including, under control of the server system, generating a measure of quality of the at least one pronunciation for a phrase in the corpus; and when there are a plurality of pronunciations for the same phrase in the corpus, a measure of quality relative to the at least one other pronunciation for the same phrase.

8. The method of claim 6 including, under control of the server system, utilizing the at least one received rating to generate a measure of quality of the at least one pronunciation for a phrase in the corpus; and when there are a plurality of pronunciations for the same phrase in the corpus, a measure of quality relative to the at least one other pronunciation for the same phrase, whereby comparatively higher quality pronunciations for each phrase in the corpus can be identified, and at least one of the higher quality pronunciations for each phrase can be sent to a client system.

9. A method for accessing a pronunciation corpus using one of a plurality of client systems, carrying out, independently of other client systems, at least one action selected from a set including:
sending to a server system a pronunciation for a phrase in the corpus;
sending to the server system a request for at least one pronunciation for at least one phrase in the corpus; and
receiving from the server system the at least one requested pronunciation.

10. The method of claim 9 wherein the set includes sending to the server system a phrase for inclusion in the corpus.

11. The method of claim 9 wherein the set includes sending to the server system at least one rating for the at least one received pronunciation.

12. The method of claim 10 wherein the set further includes sending to the server system at least one rating for the at least one received pronunciation.

13. The method of claim 10 wherein the sending includes inputting the written form of the phrase in a client system using a suitable input component of the client system.

14. The method of claim 9 wherein the sending a pronunciation includes recording, to a suitable encoding, the pronunciation to be stored in a suitable storage medium of the client system and sending the stored encoding of the pronunciation to the server system.

15. The method of claim 14 wherein the sending includes uploading the stored encoding to the server system.

16. The method of claim 14 wherein the sending includes attaching the stored encoding to an email and sending the email to the server system.

17. The method of claim 14 wherein the encoding is a computer format for multimedia materials.

18. The method of claim 14 wherein the encoding is a computer format for video and audio materials.

19. The method of claim 9 wherein the sending of a pronunciation includes capturing the utterance of a phrase by a suitable input component of the client system while the client system is partially under control of a suitable program and the program sending a suitable encoding of the utterance to the server system.

20. The method of claim 9 wherein the request includes the written form of the at least one phrase.

21. The method of claim 20 includes generating the written form by inputting the written form in a suitable program.

22. The method of claim 9 wherein the client systems and the server system communicate via one or a combination of communication networks selected from a set including the Internet, a mobile telephone network, a local area network, a satellite communication network, a mobile data network, a packet-switched network, a telephone network, and a circuit-switched network.

23. The method of claim 9 wherein the receiving includes playing back of the at least one pronunciation using a suitable output component of the client system.

24. The method of claim 23 wherein the output component is a telephone.

25. The method of claim 9 wherein the receiving includes storing a suitable encoding of the at least one pronunciation in a suitable storage medium of the client system.

26. The method of claim 9 wherein the receiving includes receiving a listing of the at least one pronunciation and displaying the listing in the client system, selecting a pronunciation from the listing, and playing back the selected pronunciation using a suitable output component of the client system under the control of a suitable program.

27. The method of claim 9 wherein the receiving includes receiving a suitable encoding of the at least one pronunciation as an attachment to an email sent by the server system to the client system.

28. The method of claim 11 wherein the rating is represented by a numerical value.

29. The method of claim 11 includes inputting the rating in a suitable program.

30. A method for generating a pronunciation corpus and making the corpus available for use by a plurality of client systems wherein a server system carries out, in no particular order, at least one action selected from a set including:
receiving from a client system a pronunciation for a phrase in the corpus;
receiving from a client system a request for at least one pronunciation for at least one phrase in the corpus; and
sending to the requesting client system the at least one requested pronunciation.

31. The method of claim 30 including receiving from a client system a phrase for inclusion in the corpus.

32. The method of claim 30 including gathering, independently from the client systems, phrases for inclusion in the corpus.

33. The method of claim 30 including receiving from a client system at least one rating for the at least one sent pronunciation.

34. The method of claim 31 further including receiving from a client system at least one rating for the at least one sent pronunciation.

35. The method of claim 31 wherein the receiving includes receiving the written form of the phrase from a client system.

36. The method of claim 30 wherein the receiving of a pronunciation includes receiving a suitable encoding of the pronunciation.

37. The method of claim 36 wherein the receiving a suitable encoding includes receiving an upload of the encoding.

38. The method of claim 36 wherein the receiving a suitable encoding includes receiving the encoding as an attachment to an email sent from a client system to the server system.

39. The method of claim 30 wherein the receiving of a pronunciation includes receiving an utterance of the phrase while a client system is partial under control of a suitable program and receiving an encoding of the utterance sent by the program.

40. The method of claim 30 wherein the request includes the written form of the at least one phrase.

41. The method of claim 30 wherein the client systems and the server system communicate via one or a combination of communication networks selected from a set including the Internet, a mobile telephone network, a local area network, a satellite communication network, a mobile data network, a packet-switched network, a telephone network, and a circuit-switched network.

42. The method of claim 30 wherein the sending includes sending a listing of the at least one pronunciation and in response to a pronunciation being selected by the client system, sending a suitable encoding of the selected pronunciation.

43. The method of claim 30 including generating a measure of quality of the at least one pronunciation for a phrase in the corpus; and when there are a plurality of pronunciations for the same phrase in the corpus, a measure of quality relative to the at least one other pronunciation for the same phrase.

44. The method of claim 33 including utilizing the at least one received rating to generate a measure of quality of the at least one pronunciation for a phrase in the corpus; and when there are a plurality of pronunciations for the same phrase in the corpus, a measure of quality relative to the at least one other pronunciation for the same phrase.

45. A client system for accessing a pronunciation corpus including:
a component configured to send to a server system a pronunciation for a phrase in the corpus;
a component configured to send to the server system a request for at least one pronunciation for at least one phrase in the corpus; and
a component configured to receive from the server system the at least one requested pronunciation.

46. The client system of claim 45 includes a component configured to send to the server system a phrase for inclusion in the corpus.

47. The client system of claim 45 includes a component configured to send to the server system at least one rating for the at least one received pronunciation.

48. The client system of claim 46 further includes a component configured to send to the server system at least one rating for the at least one received pronunciation.

49. The client system of claim 45 includes a storage medium configured to store a suitable encoding of a pronunciation.

50. The client system of claim 45 wherein the component configured to send a pronunciation includes an input component configured to record a pronunciation in a suitable encoding.

51. The client system of claim 45 wherein the component configured to send a request includes an input component configured for inputting the written form of a phrase.

52. The client system of claim 45 wherein the component configured to receive includes an output component configured to play back a pronunciation.

53. The client system of claim 45 wherein the component configured to receive includes a display component configured to display a listing of at least one pronunciation.

54. The client system of claim 53 wherein the display component includes a component configured for selecting a pronunciation from the listing.

55. The client system of claim 54 wherein the display component is a browser.

56. The client system of claim 45 includes an executive component configured to execute a suitable program configured to record a pronunciation in a suitable encoding.

57. The client system of claim 56 further includes an executive component configured to execute a suitable program configured to send a suitable encoding of a pronunciation to the server system.

58. The client system of claim 46 wherein the component configured to send further includes an input component configured for inputting the written form of a phrase.

59. The client system of claim 47 further includes a component configured for inputting a rating.

60. A server system for generating a pronunciation corpus and making the corpus available for use by a plurality of client systems including:
a component configured to receive from a client system a pronunciation for a phrase in the corpus;
a component configured to receive from a client system a request for at least one pronunciation for at least one phrase in the corpus; and
a component configured to send to the requesting client system the at least one requested pronunciation.

61. The server system of claim 60 includes a component configured to receive from a client system a phrase for inclusion in the corpus.

62. The server system of claim 60 includes a component configured to receive from a client system at least one rating for the at least one sent pronunciation.

63. The server system of claim 61 further includes a component configured to receive from a client system at least one rating for the at least one sent pronunciation.

64. The server system of claim 60 includes a storage medium configured to store a suitable encoding of a pronunciation.

65. The server system of claim 64 further includes a storage medium configured to store a phrase.

66. The server system of claim 65 further includes a storage medium configured to store an association of a phrase and a pronunciation.

67. The server system of claim 60 wherein the component configured to send includes a component configured to send a pronunciation in a suitable encoding.

68. The server system of claim 60 wherein the component configured to send includes a component configured to send a listing of at least one pronunciation.

69. The server system of claim 60 includes an executive component configured to execute a suitable program configured to generate a measure of quality of the at least one pronunciation for a phrase in the corpus; and when there are a plurality of pronunciations for the same phrase in the corpus, a measure of quality relative to the at least one other pronunciation for the same phrase.

70. The server system of claim 62 includes an executive component configured to execute a suitable program configured to utilize the at least one rating to generate a measure of quality of the at least one pronunciation for a phrase in the corpus; and when there are a plurality of pronunciations for the same phrase in the corpus, a measure of quality relative to the at least one other pronunciation for the same phrase.
